(19) United States
(12) Patent Application Publication
(10) Pub. No.: US 2025/0161128 A1
(43) Pub. Date: May 22, 2025

(54) ARTICULATING BOLSTER AND METHODS OF USE

(71) Applicant: Sizewise Rentals L.L.C., Lenexa, KS (US)

(72) Inventors: Craig Salvatore MILLER, JR., Corona, CA (US); Ricardo E. Rendon, Moreno Valley, CA (US)

(73) Assignee: Sizewise Rentals L.L.C., Lenexa, KS (US)

(21) Appl. No.: 18/949,504

(22) Filed: Nov. 15, 2024

Related U.S. Application Data
(60) Provisional application No. 63/600,177, filed on Nov. 17, 2023.

(51) Int. Cl. A61G 7/05

(52) U.S. Cl. CPC A61G 7/0525

(57) ABSTRACT

A bolster having a first section, a second section, and a third section. The bolster may include a first gap extending from a bottom side to a first point located between a midline and a top side. The bolster may include a second gap extending from the top side to a second point located between the midline and the bottom side. The first section and the third section are configured to rotate about the second section. A method of articulating the bolster may comprise the steps of urging rotation of the first section about the second section and urging rotation of the third section about the second section. The bolster may be inflated or deflated to a predetermined air pressure.

### PRIORITY DATA

This U.S. non-provisional patent application claims priority to U.S. Provisional Patent Application No. 63/600,177 filed Nov. 17, 2023, which is hereby incorporated by reference herein.

### TECHNICAL FIELD

The disclosed subject matter generally relates to bolsters and more particularly, but not necessarily exclusively, to articulating bolsters.

### SUMMARY

In some aspects, the disclosed subject matter described herein relates to a bolster including: a top side; a bottom side opposite the top side; a first section; a second section connected to the first section proximate the top side; and a third section connected to the second section opposite the first section and proximate the bottom side, wherein the first section and the third section are configured to rotate about the second section. The first section and the third section may be configured to rotate about the second section in opposite directions.

In some aspects, the disclosed subject matter described herein relates to a bolster, further including: a midline disposed between the top side and the bottom side; a first gap extending from the bottom side to a first point located between the midline and the top side; and a second gap extending from the top side to a second point located between the midline and the bottom side, wherein the first gap is located between the first section and the second section, and wherein the second gap is located between the second section and the third section.

In some aspects, the disclosed subject matter described herein relates to a bolster, further including: a first tab connected to the first section; and a second tab connected to the third section, wherein the first tab and the second tab are connected between the top side and the bottom side.

In some aspects, the disclosed subject matter described herein relates to a bolster, wherein the first tab extends outwardly from the first section, and wherein the second tab extends outwardly from the third section.

In some aspects, the disclosed subject matter described herein relates to a bolster, wherein at least one of the first tab and the second tab includes connection hardware.

In some aspects, the disclosed subject matter described herein relates to a bolster, wherein the first section, the second section, and the third section are constructed of a foam material.

In some aspects, the disclosed subject matter described herein relates to a bolster, further including a sleeve configured to receive at least a portion of the bolster within the cavity.

In some aspects, the disclosed subject matter described herein relates to a bolster, wherein the first section, the second section, and the third section include an inflatable air cell.

In some aspects, the disclosed subject matter described herein relates to a bolster, wherein the bolster is configured to abut a patient support surface.

In some aspects, the disclosed subject matter described herein relates to a bolster, wherein the bolster is configured to abut an air mattress.

In some aspects, the disclosed subject matter described herein relates to a bolster, further including a plurality of seams connecting opposing sides of the inflatable air cell along the midline.

In some aspects, the disclosed subject matter described herein relates to a bolster including: a top side; a bottom side opposite the top side; a first section; a second section pneumatically connected to the first section proximate the top side; and a third section pneumatically connected to the second section opposite the first section and proximate the bottom side, wherein the first section and the third section are configured to rotate about the second section.

In some aspects, the disclosed subject matter described herein relates to a bolster, further including: a midline disposed between the top side and the bottom side; a first gap extending from the bottom side to a first point located between the midline and the top side; and a second gap extending from the top side to a second point located between the midline and the bottom side, wherein the first gap is located between the first section and the second section, and wherein the second gap is located between the second section and the third section.

In some aspects, the disclosed subject matter described herein relates to a bolster, wherein the bolster may be adjusted to a desired air pressure.

In some aspects, the disclosed subject matter described herein relates to a bolster, wherein the bolster is configured to abut an air mattress.

In some aspects, the disclosed subject matter described herein relates to a bolster, wherein the desired pressure is about equal to or greater than an air pressure of the air mattress.

In some aspects, the disclosed subject matter described herein relates to a method of articulating a bolster including the steps of: providing a bolster including: a top side; a bottom side opposite the top side; a midline between the top side and the bottom side; a first gap partially extending from the bottom side towards the top side and terminating at a first point located between the midline and the top side; a second gap partially extending from the top side towards the bottom side and terminating at a second point located between the midline and the bottom side; a first section being defined between the first point and a head end of the bolster; a second section being defined between the first point and the second point; and a third section being defined between the second point and a foot end of the bolster; connecting the bolster to an air mattress; urging rotation of the first section upwards, thereby articulating the first section about the second section at the first point; and urging rotation of at least one of the second section and the third section upwards, thereby articulating at least one of the second section and the third section about the second point.

In some aspects, the disclosed subject matter described herein relates to a method of articulating a bolster, further including the step of one of inflating and deflating the bolster to a predetermined air pressure.

In some aspects, the disclosed subject matter described herein relates to a method of articulating a bolster, further including the step of monitoring an air pressure level of the bolster and one of inflating and deflating the bolster to a predetermined air pressure.

In some aspects, the disclosed subject matter described herein relates to a method of articulating a bolster, further including the step of connecting the bolster to an air mattress.

### BRIEF DESCRIPTION OF THE DRAWINGS

The present disclosed subject matter is described herein with reference to the following drawing figures, with greater emphasis placed on clarity rather than scale:

FIG. 1 is perspective view of an embodiment of an air mattress with an articulating bolster.

FIG. 2A is a side view of an embodiment of an air mattress with an articulating bolster.

FIG. 2B is a side view of an embodiment of an articulated air mattress with an articulating bolster.

FIG. 3 is schematic view of an articulating bolster and sleeve.

FIG. 4 is flow chart illustrating an articulation process according to embodiments of the described principles.

### DETAILED DESCRIPTION

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Although the disclosed subject matter has been disclosed with reference to various particular embodiments, it is understood that equivalents may be employed, and substitutions made herein without departing from the scope of the disclosed subject matter as recited in the claims.

Certain terminology will be used in the following description, and are shown in the drawings, and will not be limiting. For example, up, down, front, back, right and left refer to the disclosed subject matter as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

The disclosed subject matter will now be described with reference to the drawing figures, in which like reference numerals refer to like parts throughout. For purposes of clarity in illustrating the characteristics of the present disclosed subject matter, proportional relationships of the elements have not been maintained in the figures. In some cases, the sizes of certain small components have been exaggerated for illustration.

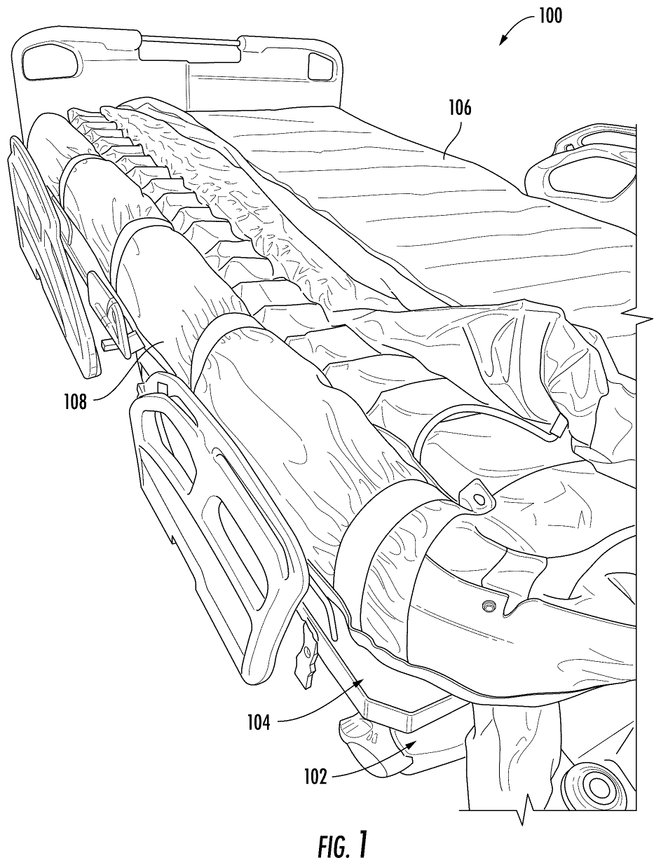

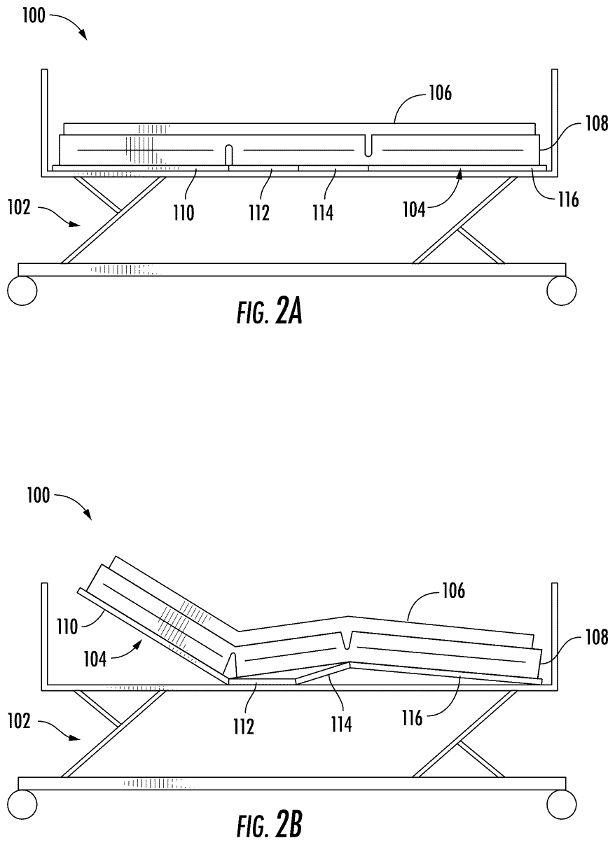

Referring to the drawings, FIG. 1, FIG. 2A, and FIG. 2B shows embodiments of a medical bed 100 having a bed frame 102, a patient support surface 104, an air mattress 106, and a bolster 108. In an embodiment, two bolsters 108 may be positioned on opposite sides of the air mattress. The patient support surface 104 may include a head section 110, an upper core section 112, a lower core section 114, and a foot section 116. The head section 110 may rotate in order to articulate the head section 110 and the air mattress 106 upwardly and away from the bed frame 102 in order to raise a patient's torso. In an embodiment, the head section 110 may use autoregression to slide away from the upper core section 112 (toward the head of the bed) and simultaneously raise upwardly from the bed frame 102 in order to prevent the air mattress 106 from sliding down on the patient support surface 104 towards the foot section 116. The upper core section 112 may be non-pivotally connected to the bed frame 102. The lower core section 114 may rotate in order to articulate the lower core section 114 and the air mattress 106 away from the bed frame 102 in order to raise the patient's legs. The lower core section 114 and foot section 116 may be pivotally connected, whereby rotation of the lower core section 114 about the upper core section 112 may articulate the foot section 116 and air mattress 106 about the lower core section 114.

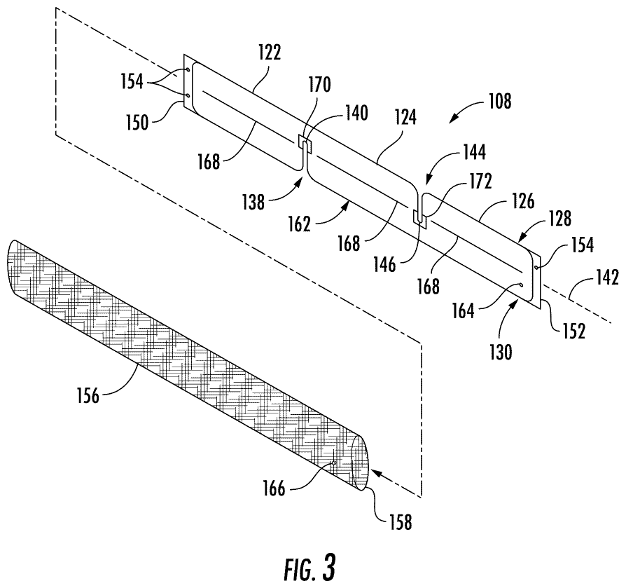

Referring to FIG. 3, the bolster 108 may include a first section 122, a second section 124, and third section 126; wherein the first section 122 is connected to the second section 124 proximate a top side 128 of the bolster 108; and wherein the second section 124 is connected to the third section 126 proximate a bottom side 130 of the bolster 108. The bottom side 130 is opposite the top side 128.

In an embodiment, the first section 122 and the second section 124 may be partially separated by a first gap 138 partially extending from the bottom side 130 towards the top side 128 and terminating at a first point 140 located between a midline 142 of the bolster 108 and the top side 128. The first section 122 and the second section 124 may both be articulated towards the top side 128 about the first point 140.

In an embodiment, the second section 124 and the third section 126 may be partially separated by a second gap 144 partially extending from the top side 128 towards the bottom side 130 and terminating at a second point 146 located between the midline 142 and the bottom side 130. The second section 124 and the third section 126 may both be articulated towards the bottom side 130 about the second point 146.

In an embodiment, the first section 122 may be at least partially positioned above the head section 110; whereby articulation of the head section 110 urges articulation of the first section 122 about the second section 124. In a similar manner, the second section 124 may be at least partially positioned above the lower core section 114, whereby articulation of lower core section 114 urges articulation of the second section 124 about the third section 126.

In some embodiments, the first section 122 and the third section 126 are configured to rotate about the second section. In an embodiment, the first section and the third section may rotate about the second section in opposite directions. For example, the first section 122 may be configured to rotate upwardly about the second section 124, while the third section 126 may be configured to rotate downwardly about the second section 124.

The bolster 108 may further include a first tab 150 and a second tab 152 for connecting the bolster 108 to the air mattress 106 or the bed frame 102. The first tab 150 may be connected to the first section 122 between the top side 128 and bottom side 130, and the second tab 152 may be connected to third section 126 between the top side 128 and bottom side 130. The first tab 150 and the second tab 152 may be generally planar in shape and extend outwardly and away from the bolster 108. At least one of the first tab 150 and the second tab 152 may include a connection hardware 154 for connecting the bolster 108 to the air mattress 106. In an embodiment, the connection hardware 154 may comprise one of a component of a snap, clasp, button, hook and loop fastener, etc.

In an embodiment, a sleeve 156 having a cavity 158 may be configured to receive at least a portion of the bolster 108 within the cavity 158. The sleeve 156 may be generally tubular in shape and constructed of a flexible material so that the sleeve 156 may flex and bend in accordance with articulation of one or more of the first section 122, the second section 124, and third section 126. In an embodiment, the flexible material may comprise a fabric or plastic. The sleeve 156 may be dimensioned so that the first tab 150 and second tab 152 extend outwardly from the cavity 158 in order to access the connection hardware 154.

In an embodiment, the first section 122, the second section 124 and the third section 126 may be constructed of a foam material to provide structural rigidity and flexibility to the bolster 108. The foam material may comprise of a polyurethane foam.

In an embodiment, the first section 122, the second section 124 and the third section 126 may comprise an inflatable air cell 162 having an air valve 164 configured to connect to an air hose (not shown) in order to inflate and deflate the inflatable air cell 162. The first section 122, the second section 124, and the third section 126 may be pneumatically connected to each other and to the air valve 164. The firmness of the inflatable air cell 162 may correlate the air pressure within the inflatable air cell 162. For example, a firmness level of the inflatable air cell 162 may increase when the air pressure within the inflatable air cell 162 increases, and conversely, the firmness level of the inflatable air cell 162 may decrease with the air pressure within the inflatable air cell 162 decreases. As such, the firmness level may be adjusted by adjustment of the air pressure within the inflatable air cell 162. The air pressure may be adjusted to a predetermined pressure level and the air valve may be sealed to maintain the predetermined pressure level. Alternatively, the air pressure may be intermittently or continuously monitored by a pressure sensor (not shown) pneumatically connected to the inflatable air cell 162 and the air pressure may be adjusted when the air pressure reaches the predetermined level within the inflatable air cell 162 as indicated by the pressure sensor. In an embodiment, the air pressure may be manually adjusted by inflating or deflating the inflatable air cell 162 through the air valve 164 with a pump (not shown).

In an embodiment of the disclosed subject matter, the desired pressure is about equal to or greater than the air pressure of the air mattress 106. The inflatable air cell 162 may further comprise a plurality of seams 168 connecting opposing sides of the inflatable air cell 162 along about the midline 142. The plurality of seams 168 provide additional structural stability and rigidity to the first section 122, the second section 124 and the top side 128. The first section 122, the second section 124, and the third section 126 may pneumatically connect to the air valve 164 and may inflate and deflate to a desired air pressure. In an embodiment, the exterior surface the inflatable air cell 162 comprises a first reinforced section 170 proximate the first point 140, and a second reinforced area 172 proximate the second point 146. The first reinforced section 170 and second reinforced area 172 may include a thickness of material connected to the exterior surface of the inflatable air cell 162 in order to structurally reinforce the inflatable air cell 162 to distribute additionally stresses at the first point 140 and the second point 146 due to articulation of the first section 122, the second section 124, and the third section 126. In an embodiment, the inflatable air cell 162 may be constructed of gas tight material, such as by way of example, a rubber or a plastic. In an embodiment, the sleeve 156 may include an aperture 166 sized to accommodate the air valve 164.

### Methods of Use

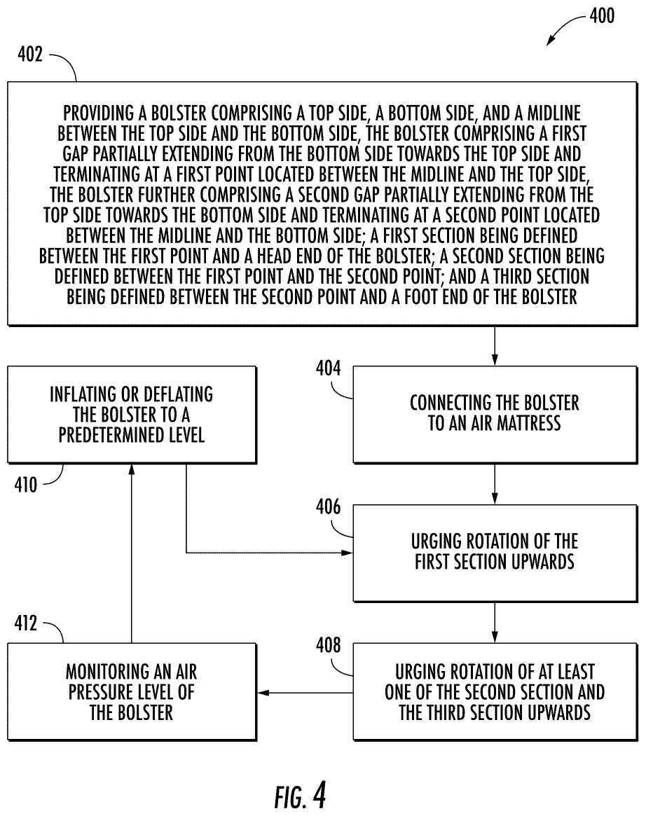

Referring to FIG. 4, a method 400 of articulating a bolster may comprise the steps of: (step 402) providing a bolster comprising a top side, a bottom side, and a midline between the top side and the bottom side, the bolster comprising a first gap partially extending from the bottom side towards the top side and terminating at a first point located between the midline and the top side, the bolster further comprising a second gap partially extending from the top side towards the bottom side and terminating at a second point located between the midline and the bottom side; a first section being defined between the first point and a head end of the bolster; a second section being defined between the first point and the second point; and a third section being defined between the second point and a foot end of the bolster; (step 404) connecting the bolster to an air mattress; (step 406) urging rotation of the first section upwards; thereby articulating the first section about the second section at the first point; and (step 408) urging rotation of at least one of the second section and the third section upwards, thereby articulating at least one of the second section and the third section about the second point.

The method 400 may further comprise the step of one of inflating and deflating the bolster to a predetermined air pressure (step 410).

The method 400 may further comprise the step of monitoring an air pressure level of the bolster and one of inflating and deflating the bolster to a predetermined air pressure (step 412).

It is to be understood that while certain aspects of the disclosed subject matter have been shown and described, the disclosed subject matter is not limited thereto and encompasses various other embodiments and aspects.

What is claimed is:

1. A bolster comprising:
a top side;
a bottom side opposite the top side;
a first section;
a second section connected to the first section proximate the top side; and
a third section connected to the second section opposite the first section and proximate the bottom side,
wherein the first section and the third section are configured to rotate about the second section.

2. The bolster of claim 1, further comprising:
a midline disposed between the top side and the bottom side;
a first gap extending from the bottom side to a first point located between the midline and the top side; and
a second gap extending from the top side to a second point located between the midline and the bottom side,
wherein the first gap is located between the first section and the second section,
wherein the second gap is located between the second section and the third section.

3. The bolster of claim 1, further comprising:
a first tab connected to the first section; and
a second tab connected to the third section,
wherein the first tab and the second tab are connected between the top side and the bottom side.

4. The bolster of claim 3, wherein the first tab extends outwardly from the first section, and wherein the second tab extends outwardly from the third section.

5. The bolster of claim 4, wherein at least one of the first tab and the second tab comprises connection hardware.

6. The bolster of claim 1, wherein the first section, the second section, and the third section are constructed of a foam material.

7. The bolster of claim 1, further comprising a sleeve having a cavity, the sleeve configured to receive at least a portion of the bolster within the cavity.

8. The bolster of claim 2, wherein the first section, the second section, and the third section comprise an inflatable air cell.

9. The bolster of claim 1, wherein the bolster is configured to abut a patient support surface.

10. The bolster of claim 9, wherein the bolster is configured to abut an air mattress.

11. The bolster of claim 8, further comprising a plurality of seams connecting opposing sides of the inflatable air cell along the midline.

12. A bolster comprising:
a top side;
a bottom side opposite the top side;
a first section;
a second section pneumatically connected to the first section proximate the top side; and
a third section pneumatically connected to the second section opposite the first section and proximate the bottom side,
wherein the first section and the third section are configured to rotate about the second section.

13. The bolster of claim 12, further comprising:
a midline disposed between the top side and the bottom side;
a first gap extending from the bottom side to a first point located between the midline and the top side; and
a second gap extending from the top side to a second point located between the midline and the bottom side,
wherein the first gap is located between the first section and the second section,
wherein the second gap is located between the second section and the third section.

14. The bolster of claim 12, wherein the bolster may be adjusted to a desired air pressure.

15. The bolster of claim 14, wherein the bolster is configured to abut an air mattress.

16. The bolster of claim 14, wherein the desired pressure is about equal to or greater than an air pressure of the air mattress.

17. A method of articulating a bolster comprising the steps of:
providing a bolster comprising:
a top side;
a bottom side opposite the top side;
a midline between the top side and the bottom side;
a first gap partially extending from the bottom side towards the top side and terminating at a first point located between the midline and the top side;
a second gap partially extending from the top side towards the bottom side and terminating at a second point located between the midline and the bottom side;
a first section being defined between the first point and a head end of the bolster;
a second section being defined between the first point and the second point; and
a third section being defined between the second point and a foot end of the bolster;
connecting the bolster to an air mattress;
urging rotation of the first section upwards, thereby articulating the first section about the second section at the first point; and
urging rotation of at least one of the second section and the third section upwards, thereby articulating at least one of the second section and the third section about the second point.

18. The method of claim 17, further comprising the step of one of inflating and deflating the bolster to a predetermined air pressure.

19. The method of claim 18, further comprising the step of monitoring an air pressure level of the bolster and one of inflating and deflating the bolster to a predetermined air pressure.

20. The method of claim 17, further comprising the step of connecting the bolster to an air mattress.
